(19) United States
(12) Patent Application Publication
(10) Pub. No.: US 2018/0086533 A1
(43) Pub. Date: Mar. 29, 2018

(54) CRYOGENIC STORAGE RECEPTACLE FOR RFID DATA

(71) Applicant: United States of America as Represented by The Secretary of The Army, Alexandria, VA (US)

(72) Inventor: Michael E. Kjelland, Vicksburg, MS (US)

(21) Appl. No.: 15/280,821

(22) Filed: Sep. 29, 2016

(51) Int. Cl. B65D 81/18; B65D 85/50; B65D 83/00; G06F 19/00; G06K 7/10

(52) U.S. Cl. CPC B65D 81/18; B65D 85/50; G06K 7/10297; G06F 19/327; B65D 83/0022

(57) ABSTRACT

The present invention is a cryogenic storage receptacle for RFID data made up of a cryogenic container having a delivery end and a tag end partially closed by a pressure equalization cap. An RFID tag is located adjacent to the tag end. Partial closure of the tag end by pressure equalization cap allows a plunger arm to push the plunger and expel the biological material for in vivo fertilization and implantation procedures. This configuration also allows pressure equalization during freezing and thawing, preventing the pressure equalization cap from becoming dislodged and avoiding loss of the RFID tag.

### STATEMENT REGARDING FEDERALLY SPONSORED RESEARCH OR DEVELOPMENT

The invention described herein was made by an employee of the United States Government and may be manufactured and used by the Government of the United States of America for governmental purposes without the payment of any royalties thereon or therefore.

### FIELD OF INVENTION

This invention relates to the field of reproduction and fertilization, and more specifically to a container system for cryogenic storage of biological material.

### BACKGROUND OF THE INVENTION

Livestock breeders spend hundreds of billions of dollars each year on biological material, such as sperm and embryos, which allow selective breeding of traits from geographically disparate animals. Highly-value livestock, such as champion bulls, may produce thousands of units of material each year, with each unit selling for several hundred dollars. Once obtained, biological material is stored in containers at very low temperatures, in some cases down to almost −200 degrees Celsius. The containers are thawed before use, allowing in vivo fertilization and implantation.

Before storage, the containers receive identifying markings such as bar codes, etchings on the containers, or printed labels. There are several problems known in the art with these identifiers. One problem known in the art is that a user may be unable to read the identifiers. Because the containers are stored at very low temperatures, frost may accumulate over the markings. Vapors or fluids from refrigeration or liquid nitrogen may also render the markings unreadable. Lifting the containers out of cryogenic liquid can prematurely thaw and destroy the material. Another problem is that in large groupings of containers, a user may experience difficulty locating a particular container.

Attempts have been made in the prior art to use radiofrequency identification (RFID) tags attached to the container. For example, Cryogatt, located in the United Kingdom, manufactures cryogenic containers covered by sleeves with RFID tags. During freezing, such sleeves may contract at a different rate from the cryogenic containers, damaging the sleeve or container. RFID tags directly attached to an outer surface of a container may fall off during freezing. Tags located inside the container may be accidentally implanted in livestock during fertilization, as these tags can be smaller than a grain of rice.

Tags in separate compartments of the container, covered by caps, are more difficult to lose during freezing or implantation. However, these tags are frequently lost due to the inability to equalize pressure during freezing or thawing. Any air present in the separate compartment of the container will substantially contract during freezing, potentially breaking or dislodging the cap. Upon thawing, the air will expand, expelling the cap and causing loss of the RFID tag.

There is an unmet need in the art for an RFID-enabled cryogenic container which does not risk the loss of the tag during freezing, thawing, or fertilization.

### BRIEF SUMMARY OF THE INVENTION

The present invention is a cryogenic storage receptacle for RFID data made up of a cryogenic container having a delivery end and a tag end partially closed by a pressure equalization cap. Biological material is stored adjacent to the delivery end, with a plunger between the delivery end and the tag end. An RFID tag is located adjacent to the tag end. Partial closure of the tag end allows use of the apparatus for in vivo fertilization and implantation procedures, as well as pressure equalization during freezing and thawing.

### BRIEF DESCRIPTION OF SEVERAL VIEWS OF THE DRAWING(S)

FIG. 1 illustrates a cross-sectional view of an exemplary embodiment of a cryogenic storage receptacle for RFID data.

### TERMS OF ART

As used herein, the term “active RFID” refers to an RFID tag which includes an RF antenna, an electromagnetic data storage means, and an independent power source.

As used herein, the term “cryogenic container” refers to a container capable of being frozen to at least −25 degrees Celsius.

As used herein, the term “passive RFID” refers to an RFID tag which includes an RF antenna and an electromagnetic data storage means, but not an independent power source.

As used herein, the term “RFID tag” refers to a device which uses radiofrequencies for identification.

### DETAILED DESCRIPTION OF THE INVENTION

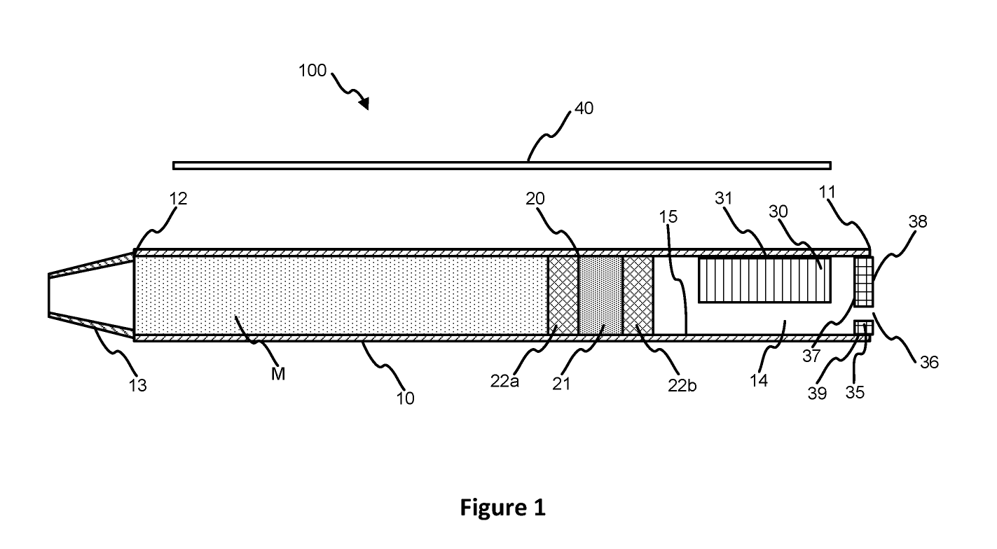

FIG. 1 illustrates a cross-sectional view of an exemplary embodiment of cryogenic storage receptacle for RFID data 100.

Receptacle 100 includes a cylindrical cryogenic container 10 enclosing a quantity of biological material M, and a plunger 20 located between biological material M and an RFID tag 30. In certain embodiments, cryogenic container 10 has a rectangular cross-section. A pressure equalization cap 35 on one end of cryogenic container 10 allows a user to manipulate a plunger arm 40 to push plunger 20 and expel biological material M. Plunger arm 40 may be inserted into cryogenic container 10, as in the exemplary embodiment, or may be integral to plunger 20. Biological material may be any biologically-based material such as sperm, ova, embryos, cells, cell components, genetic material, or any combination thereof.

Cryogenic container 10 is a glass or polymer tube having a tag end 11 and a delivery end 12. In the exemplary embodiment, cryogenic container 10 also includes a delivery cap 13 sealing off delivery end 12. In other embodiments, delivery end 12 is sealed shut. When plunger arm 40 pushes plunger 20 towards delivery end 12, plunger 20 expels biological material M from delivery end 12. In the exemplary embodiment, delivery cap 13 has at least one diameter smaller than at least two dimensions of RFID tag 30, thereby preventing expulsion of RFID tag 30. In other embodiments, delivery end 12 may taper to a diameter smaller than at least two dimensions of RFID tag 30, thereby also preventing expulsion of RFID tag 30. Plunger 20 is made of a layer of moisture-absorbing material 21 such as, but not limited to, polyvinylpyrrolidone (PVP) powder 21, sandwiched between two layers of cotton wadding 22a and 22b.

RFID tag 30 is located in tag end 11. In the exemplary embodiment, RFID tag 30 is a passive tag. In other embodiments, RFID tag 30 is an active tag. RFID tag 30 may be selected to accommodate temperatures ranging from approximately −25 degrees Celsius to approximately −200 degrees Celsius. RFID tag 30 is located within a pressure equalization chamber 14 between plunger 20 and an interior cap wall 37. In the exemplary embodiment, RFID tag 30 is attached to an interior wall 15 of pressure equalization chamber 14, through the use of an attachment interface 31 created by adhesive or ultrasonic welding. In another embodiment, RFID tag 30 is attached by the same means as above to interior cap wall 37. In still other embodiments, RFID tag 30 is not attached to any other structure, but is “loose” within pressure equalization chamber 14.

In the exemplary embodiment, RFID tag 30 includes an electromagnetically coded interface which is associated with a computer configured with software. The software creates a data structure which is stored in a computer database. The data structure includes attributes which provide identifying information for biological material M. These attributes may include a numeric or alphanumeric identifier, the biological or commercial source of biological material M (i.e. identification of the animal or of the animal's owner), a batch number of biological material M, a preparation number of biological material M, the collection date of biological material M, the numeric or alphanumeric identifier of the originating agency that obtained biological material M, the method of obtaining biological material M, a certification number for biological material M, any other information which may be pertinent, and any combination thereof. Batch number refers to the number of samples of biological material M obtained from the biological source, while preparation number refers to the order in which quantities of biological material M from a batch were frozen. A certification number identifies a certification of the health or quality of either biological material M or the source. A user may update the interface if receptacle 100 is sterilized and used to store another quantity of biological material M.

Pressure equalization cap 35 is sized to prevent the loss of RFID tag 30 but does not completely close off tag end 11, instead creating a cap aperture 36. Cap aperture 36 allows movement of plunger arm 40 through tag end 11 and pressure equalization chamber 14 to expel biological material M, and also allows pressure equalization of the air around RFID tag 30. Without pressure equalization, the rapid expansion or contraction during thawing or freezing of any air present in pressure equalization chamber 14 may cause damage to cryogenic container 10 or cause pressure equalization cap 35 to separate, resulting in loss of RFID tag 30. In the exemplary embodiment, cap aperture 36 is a channel through pressure equalization cap 35. In other embodiments, cap aperture 36 is a channel formed by and between a cap sidewall 39 of pressure equalization cap 35 and interior wall 15. In certain embodiments, RFID tag 30 is connected to an interior cap wall 37 opposite exterior cap wall 38.

In the exemplary embodiment, plunger arm 40 is a wire or a rod made from biologically inert metals, biologically inert polymers, or combinations thereof. In the exemplary embodiment, plunger arm 40 has a length shorter than cryogenic container 10 to prevent plunger arm 40 from inadvertently expelling RFID tag 30. In the exemplary embodiment, plunger arm 40 also has a diameter allowing insertion through cap aperture 36.

It will be understood that many additional changes in the details, materials, procedures and arrangement of parts, which have been herein described and illustrated to explain the nature of the invention, may be made by those skilled in the art within the principle and scope of the invention as expressed in the appended claims. Moreover, the terms “substantially” or “approximately” as used herein may be applied to modify any quantitative representation that could permissibly vary without resulting in a change in the basic function to which it is related.

It should be further understood that the drawings are not necessarily to scale; instead, emphasis has been placed upon illustrating the principles of the invention.

What is claimed is:

1. A cryogenic storage receptacle apparatus for RFID data, comprising:
a cryogenic container having a delivery end and a tag end, wherein a plunger is located between said delivery end and said tag end,
a pressure equalization cap partially sealing said tag end, wherein said pressure equalization cap is comprised of an interior cap wall, an exterior cap wall, and a cap aperture; and
an RFID tag enclosed within a pressure equalization chamber between said plunger and said interior cap wall of said pressure equalization cap, wherein said RFID tag is located within said cryogenic container between said plunger and said pressure equalization cap, and is unattached to said cryogenic container, said plunger, and said pressure equalization cap.

2. The apparatus of claim 1, wherein said delivery end tapers to a diameter smaller than at least two dimensions of said RFID tag.

3. The apparatus of claim 1, wherein said delivery end is sealed by a delivery cap.

4. The apparatus of claim 3, wherein said delivery cap has at least one diameter smaller than at least two dimensions of said RFID tag.

5. The apparatus of claim 1, wherein said cap aperture is a channel extending from said interior cap wall to said exterior cap wall.

6. The apparatus of claim 1, wherein said cap aperture is a channel formed between an interior wall of said cryogenic container and a sidewall of said pressure equalization cap.

7. The apparatus of claim 1, wherein aid RFID tag is a passive RFID tag.

8. The apparatus of claim 1, wherein said RFID tag is an active RFID tag.

9. (canceled)

10. A cryogenic storage receptacle apparatus for RFID data, comprising:
a cryogenic container having a delivery end and a tag end, wherein a plunger is located between said delivery end and said tag end,
a pressure equalization cap partially sealing said tag end, wherein said pressure equalization cap is comprised of an interior cap wall, an exterior cap wall, and a cap aperture; and
an RFID tag enclosed within a pressure equalization chamber between said plunger and said interior cap wall of said pressure equalization cap, wherein said RFID tag is attached to said interior cap wall of said pressure equalization cap.

11. The apparatus of claim 10, wherein said RFID tag is attached to said interior cap wall by an ultrasonic welding attachment interface.

12. The apparatus of claim 10, wherein said RFID tag is attached to said interior cap wall by an adhesive attachment interface.

13. (canceled)

14. The apparatus of claim 21, wherein said RFID tag is attached to said interior wall by an ultrasonic welding attachment interface.

15. The apparatus of claim 21, wherein said RFID tag is attached to said interior wall by an adhesive attachment interface.

16. The apparatus of claim 1, wherein said RFID tag further includes an electromagnetically coded interface which is associated with a computer configured with software, wherein said software creates a data structure which is stored in a computer database.

17. The apparatus of claim 16, wherein said data structure includes attributes relating to a quantity of biological material, said attributes selected from a group consisting of: at least one numeric or alphanumeric identifier, a biological source, a commercial source, a batch number, a preparation number, a collection date, a numeric or alphanumeric identifier of an originating agency, a method of obtaining, a certification number, and any combination thereof.

18. The apparatus of claim 1, further comprising a plunger arm having a diameter smaller than a diameter of said cap aperture

19. The apparatus of claim 18, wherein said plunger arm is a wire or a rod comprising a material selected from the group consisting of: biologically inert metals, biologically inert polymers, and combinations thereof.

20. The apparatus of claim 18, wherein said plunger arm has a length shorter than a length of said cryogenic container.

21. A cryogenic storage receptacle apparatus for RFID data, comprising:
a cryogenic container having a delivery end and a tag end, wherein a plunger is located between said delivery end and said tag end,
a pressure equalization cap partially sealing said tag end, wherein said pressure equalization cap is comprised of an interior cap wall, an exterior cap wall, and a cap aperture; and
an RFID tag enclosed within a pressure equalization chamber between said plunger and said interior cap wall of said pressure equalization cap, wherein said RFID tag is attached to an interior wall of said cryogenic container between said plunger and said pressure equalization cap.
